(19) United States
(12) Patent Application Publication
(10) Pub. No.: US 2009/0031144 A1
(43) Pub. Date: Jan. 29, 2009

(54) REVOCATION MESSAGE CYCLING IN A DIGITAL TRANSMISSION CONTENT PROTECTION SYSTEM

(76) Inventor: JIM C. WILLIAMS, Yorba Linda, CA (US)

Correspondence Address: CONNOLLY BOVE LODGE & HUTZ LLP, P.O. BOX 2207, WILMINGTON, DE, 19899, US

(21) Appl. No.: 11/828,173

(22) Filed: Jul. 25, 2007

(51) Int. Cl. G06F 11/30

(52) U.S. Cl. 713/193

(57) ABSTRACT

In a digital Content Protection System (CPS), System Renewability Messages (SRM's) are managed at an administrative level to prioritize and select SRM's depending on transmission region and/or time. The highest-priority SRM's may be selected to fit in a receiver memory size specified by a CPS. SRM's may be cycled so that different subsets of the total set of SRM's are selected for highest priority use of limited storage capacity at different times, thereby extending the effectiveness of revocation beyond the otherwise limiting factor of SRM storage capacity.

### BACKGROUND OF THE INVENTION

1. Field of the Invention

The present invention relates to Content Protection Systems (CPS) like Digital Transmission Content Protection for Internet Protocol (DTCP-IP) and other equivalent systems that provide for protection of digital content.

2. Description of Related Art

Digital entertainment content and broadband distribution have enabled efficient and fast distribution of copyrighted content from the distributor directly to the consumer. At the same time, various CPS methods and systems have been developed to discourage or prevent unauthorized copying or unauthorized access to copyrighted content. One such CPS comprises Digital Transmission Content Protection (DTCP).

Originally implemented for IEEE 1394 and USB transmission networks, DTCP has been adapted to Internet Protocol (IP) based networks for broadband distribution of entertainment content. DTCP-IP is designed to protect digital data as it is being transmitted from one device to another device. Other CPSs perform this same function, e.g., the High-bandwidth Digital Content Protection (HDCP) CPS and the Windows Media DRM for Networked Devices (WMDRM-ND). Some CPSs further provide for a persistent protection of the digital content even after reception by the receiving device, e.g., the Secure Video Processor (SVP) CPS and the Digital Video Broadcasting (DVB) standardized system called Content Protection and Copy Management (CPCM). All of these CPSs are intended to help ensure interoperability between consumer receiving devices for content, and provide a robust and transparent management system for digital information. DTCP and other CPSs are designed to facilitate transmission and use of digital copyrighted content to and across a range of consumer receiving devices, for example, televisions, desktop PCs, laptops, media centers, portable media devices, and car entertainment systems.

In particular, it is generally desirable to enable consumers to view digital entertainment content on some or all receiving devices that are part of, or that regularly connect to, a home-based network. For example, it may be desirable for television programming to be viewed on multiple televisions within a home network, or on a portable device that connects regularly to the home network. At the same time, it may be desirable to prevent transmission or use of the content outside of the home network. DTCP and other CPSs are designed to enable product manufacturers and service providers to protect designated audiovisual content from unauthorized use or redistribution beyond the home network, or other intended constrained usage. In general, unauthorized use of protected content may include any unauthorized access, for example, viewing or otherwise playing the content on an output device, copying the content, storing it, or retransmitting the content.

Receiving devices, such as PC's and consumer electronics equipment, are manufactured to comply with the standard. Content may be viewed and sometimes stored by compliant and authorized devices. In order to participate in a CPS a device needs to abide by certain technological specifications and license obligations.

As a practical matter, all CPSs are subject to attacks on the technology or robustness of the implementation of that technology. The technologies used within a CPS as a whole are often more difficult to break than certain implementations of the CPS technology on particular receiving devices. In other words, individual receiving devices may sometimes be vulnerable to being compromised, or “hacked.” Typically, a CPS will include procedures for discontinuing certain devices or classes of devices from participation within the trusted community of devices that comprise that CPS, as a way for preventing compromised receiving devices from accessing protected content.

Typically, each device has a unique identification number that is securely contained within the implementation, e.g., within a certificate. Each device will also be privy to certain secrets that allow it to establish trust with other members of the CPS and to securely exchange content. If a particular receiving device is attacked, its secrets are stolen, and then new devices are created using those same secrets, then the overall security of the CPS may be compromised. For example, the new devices may use a cloned certificate and CPS implementation that does not abide by other compliance rules associated with the license of that CPS.

Revocation is a method that is commonly used in CPSs to address this type of security breach, in which receiving devices with cloned secrets, certificates and identification numbers are masquerading as legitimate members of the CPS. Using investigative techniques, which may comprise physical inspection or the use of forensic watermarks that are commonly understood by those familiar with this field, the unique identification number of the original CPS device that was attacked and cloned is determined. This number is then added to a list of so-called revoked devices. This list is commonly called a Certificate Revocation List (CRL). Each CPS has a particular format for these messages and particular requirements for each CPS device to use these messages when it is establishing trust with another member of the CPS. A commonplace condition for establishing trust between two devices of a CPS requires that they each have access to the secrets that are held by all members of that CPS, and they must confirm that the other device's unique identification number is not on the CRL, i.e., that it has not been revoked.

CRLs are transmitted or otherwise transported from the licensing authority of the CPS to each of the member devices in that CPS. The method of transport may include pre-loading into new devices; placement on physical media, e.g., DVDs, which might be eventually played by devices that are members of that CPS; transmission over terrestrial, cable, satellite or IPTV systems; retrieval by the CPS device over an Internet connection; or any other suitable method. Often the message that is used to convey the CRL is called a System Renewability Message (SRM), in that the integrity of the CPS is renewed by exclusion of the cloned and untrustworthy devices that are listed on the CRL. For example, the ATSC has standardized a method for transporting SRMs within an ATSC terrestrial broadcast bitstream in Document A/98, Jan. 3, 2007,

In an example CPS, DTCP-IP establishes four primary components for protection of content. These components are (1) Authentication & Key Exchange (AKE), (2) Advanced Encryption Standard (AES), (3) Extended Encryption Mode Indicator (E-EMI), and (4) Renewability Messaging. According to the standard, compliant communicating devices must first confirm their identities and authorization to one another and then exchange the appropriate cryptographic information to support the session, using AKE. Compliant devices use an AES cipher to control access to encrypted content. E-EMI is used with additional copy control information embedded directly in the content stream to identify whether content is allowed to be copied, time shifted, retransmitted, and so on. Renewability messaging allows authorized administrators to revoke the authorization of rogue devices, for example, an unauthorized device that mimics a compliant authorized device using a reverse-engineered chip. Often, a particular unauthorized device is replicated for unauthorized sales. It is therefore often possible to discover one of the replicated rogues, and by issuing an SRM, prevent all replicas of the rogue device from accessing protected content. One or more designated administrators can issue System Renewability Messages (SRMs) that DTCP-IP-enabled devices use to revoke devices whose secret keys have been compromised and either publicly distributed or incorporated in unauthorized devices. The devices after being revoked are still capable of accessing and playing unprotected content.

SRM's are distributed with new content to DTCP-compliant receiving devices. Each SRM contains a list of devices to be revoked, which is stored by the receiving device. That device subsequently consults the list when communicating with other devices. Revocation can occur during initial authentication for protected content, when a transmitting device matches the identity of the device being authenticated to the list of revoked devices in the SRM. Devices that are found in the SRM list are not permitted to complete the authentication protocol and do not receive the keys needed to decrypt DTCP-protected content. Compliant devices that are not found in the SRM list complete the authentication protocol and receive the keys and the SRM list.

A key feature of DTCP therefore includes distributing SRM's to compliant devices. The compliant devices then operate to prevent use of protected content by unauthorized devices listed in the SRM. Thus, an administrator can much more easily prevent the propagation of rogue devices from eroding the proper functioning of the content protection system. FIG. 1 illustrates how an updated SRM might enter a home and populate a Digital Home network 50. Digital content containing a hypothetical SRM version 3 may enter a home where all of the devices presently have an earlier SRM version 2. Version 3 includes a revocation entry for the rogue device 62, which may, for example, be identified as having keys reverse-engineered from another licensed device.

A set-top box (STB) 52 may receive digital content, such as a movie 54, that contains SRM version 3, and determine that this version is more current than the one it already has. The STB verifies that the SRM is legitimate using the licensing administrator's public key and then updates its own version with the new one. When the Digital Television (DTV) 56 receives content from the STB, the DTV determines during authentication that the STB has a newer version of the SRM. It then receives the SRM from the STB, verifies the integrity of the new SRM, and updates its stored copy. Subsequently, a DVD 60 that contains SRM version 2 may be placed into the DVD player. The DVD player then discovers during authentication with the DTV that the DTV has a newer version of the SRM than the one that both the DVD player and the DVD have. The DVD player then requests a copy of SRM version 3. After verification, the DVD player updates its own SRM version. The SRM version 3 has now been fully promulgated in the digital home network, causing revocation of the rogue device 62. Thereafter, the rogue device will be unable to decrypt protected content.

Notwithstanding the advantages of revocation messaging in CPSs, this system is subject to certain limitations. For example, memory allocated for storage of SRM lists in compliant devices may be limited. In general, CPSs have some form of limitation on the amount of storage that might be required and expected to be available for storage of SRMs. The amount of storage typically expected for CPSs is on the order of hundreds or at most thousands of revocation messages. Therefore, the SRM method of renewal is limited to countering a certain number of breaches of security. If the security is breached a significantly larger number of times than an applicable storage limit, then the CPS may lose its impact and effectiveness. It is therefore desirable to overcome this and other limitations of revocation messaging in Content Protection Systems.

### SUMMARY OF THE INVENTION

Embodiments of the present invention provide methods and systems for extending the effectiveness of the present SRM methods and systems beyond the limitations described in the preceding section by managing the distribution of revocation messages, such as SRM's, in a CPS system that uses revocation messages for content protection, such as DTCP. These embodiments provide numerous capabilities that may be used to enhance content protection by focusing revocation messages on the highest-priority threats. The embodiments may also be used to increase the number of rogue devices that may be disrupted beyond the number that would otherwise be permitted by SRM memory limits in compliant reception devices.

In an embodiment of the invention, a method is provided for providing a time dependent and/or region-dependent list of SRM's for distribution at a particular time or in a particular geographic region. According to this embodiment, data concerning rogue devices may be collected in any suitable manner and provided to an SRM administrator. The data may comprise an identifier for each rogue device that is compliant with the applicable DTCP standard. The data may further comprise information for assessing time-dependent and region-dependent threat indices posed by a particular device, including, for example, an estimate of the number of duplicate rogue devices in existence, a geographic region where the devices are available, an estimated date that distribution of the rogue began, the date the first rogue device was discovered, the type of rogue device, and any other information that may be useful in assessing a threat posed by an unauthorized rogue device. Generally, an objective of providing different SRM's is to hinder unauthorized operation of non-compliant rogue devices to a maximal degree, while having minimal impact on operation of compliant devices. It should be apparent that it may not be possible to prevent all unauthorized operation of non-compliant devices, but at the same time it should be possible to cause sufficient disruption to illegal devices such that economic incentives for purchasing and owning non-compliant devices are reduced or eliminated.

The SRM administrator may process the data concerning rogue devices to compile a database or list of rogue devices that associates an identifier for each rogue device with one or both of a time-related threat index and a region-related threat index. For example, if the SRM administrator believes that a particular rogue device that was first discovered on Jan. 1, 2007 has been very widely distributed, the administrator may assign a high threat level index associated with the 1/1/07 date. For further example, if the rogue device is known to be generally available in Asia but not in North America, the administrator may assign a high threat index for Asia and a low threat index for North America. In an embodiment of the invention, the administrative database of rogue devices is fluid and may be revised at any time to reflect new information concerning extant rogue devices known to the administrator.

Periodically, the SRM administrator may generate a new version of a system SRM list for distribution to DTCP-compliant reception devices, using the administrative database and an SRM list-generating algorithm. A different SRM list may be generated for distribution in different regions, for example, Regions 1-6 of the DVD standard, or any other geographic region. Alternatively, one of the other methods of distribution might be used, like broadcast television. For broadcast television, the SRMs to be broadcast may be prioritized using the statistics of the particular geographic area to maximize the exclusion of cloned devices known to be prevalent in that area.

The SRM list-generating algorithm may apply a set of prioritization rules to data in the administrative database to produce an SRM list that is compliant with the applicable DTCP or other standard. For example, to produce a list for distribution in Region 1, the algorithm may exclude records for every rogue device that is not listed as a threat in Region 1. In addition, or in the alternative, the algorithm may apply a time-based criterion to rank rogue devices in a priority order according to threat index and age. For example, a more recently-discovered rogue device may be ranked higher in the SRM-list than an older device having the same threat index. In an embodiment of the invention, the algorithm may truncate the SRM list to eliminate the lowest-priority threats if the SRM list is of a size that exceeds the memory capacity required for reception devices according to the standard.

In an embodiment of the invention, the SRM algorithm may operate to cycle SRM lists when the SRM list becomes too large to be accommodated by a standard reception device. For example, if it is desired to disrupt 300 sets of cloned device types in a region, but the standard reception device can only store SRMs for 100 cloned or stolen certificates that were used to clone those rogue device types, the algorithm may generate three successive versions of the SRM list, each containing listings for 100 different sets of cloned device types. Each version may be released in succession, with a pause between successive releases. For example, a Version 1 with a list of the first hundred rogue devices may be released, and some time later, a Version 2 list containing a list of the second hundred may be released. Some time after Version 2, Version 3 may be released, completing the cycle. The cycle may then be repeated. Any desired amount of time may be used between each release of a cycle, for example, one second, one minute, one hour, one day, or one week. Shorter periods of time may be more appropriate for broadcast, cable, or satellite distribution of content. The period of time may also vary between each successive cycle, and need not be strictly defined.

Various CPSs may use different methods for ensuring that the latest version of SRMs is retained within the storage of the device. One way to ensure that new SRMs replace the old SRMs is to ensure that they have a latter version number. Depending on the CPS, this may lead to the exhaustion of the set of possible version numbers. This can be solved by allowing the version numbers to roll over so that the zeroth version overwrites the last version, or alternatively to add a forced replacement message that requires use of the currently transmitted list in place of the currently stored list.

Over time, as different releases of a SRM list are cycled through a distribution area, the effect may be to cycle rogue devices in an area in an on/off fashion. When listed on the current version of the SRM list, the rogue device should not be able to use protected information. However, if the rogue device is removed from a subsequent version, it may again be able to use protected content until it again appears again on a later version of the SRM list.

Each version in a cycle may be generated using the most recent data in the SRM administrative database, which may include data about prior SRM list releases for each rogue device. In this way, each release may include updated information. In an embodiment of the invention, each release may constitute a fresh prioritization of available data, with selections weighted according to the total number of devices to be cycled and the number of cycles since a device was last included in a distributed SRM list. For example, when the administrative database contains ‘3x’ number of records, where ‘x’ is the minimum number of records a compliant receiving device is required to hold, each record would be included in one of every three releases. As the total number of records grew, the number of cycles between recurrent releases of a record would increase.

In an embodiment of the invention, prioritization and cycling may be combined so that the number of times a particular record is included in a release may vary according to its priority level. For example, the highest priority records may be included in every other release, or in every release, while a lower priority record may be included in every third or fourth release.

In several of the foregoing embodiments, an automated process may be used to cycle a larger set of SRM's in an administrative database to a smaller set of receiver-stored SRM's over time. A more complete understanding of revocation message cycling in a Content Protection System will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a schematic diagram showing a prior-art DTCP system.

FIG. 2 is a schematic diagram showing an exemplary system for managing revocation data.

FIG. 3 is a diagram showing exemplary aspects of an administrative database for managing revocation data.

FIG. 4 is a time chart showing an exemplary effect of implementing periodic revocation on a rogue device.

FIG. 5 is a flow chart showing exemplary steps of a method for managing release of revocation messages in a content protection system.

FIG. 6 is a flow chart showing exemplary steps of a method for selecting records from an administrative database for inclusion in distributed SRM lists.

### DETAILED DESCRIPTION OF THE PREFERRED EMBODIMENT

Revocation message cycling as summarized above provides useful, concrete and tangible results when applied in Content Protection System, for example, in a DTCP system. In the detailed description that follows, these results may be appreciated by consideration of the disclosed embodiments.

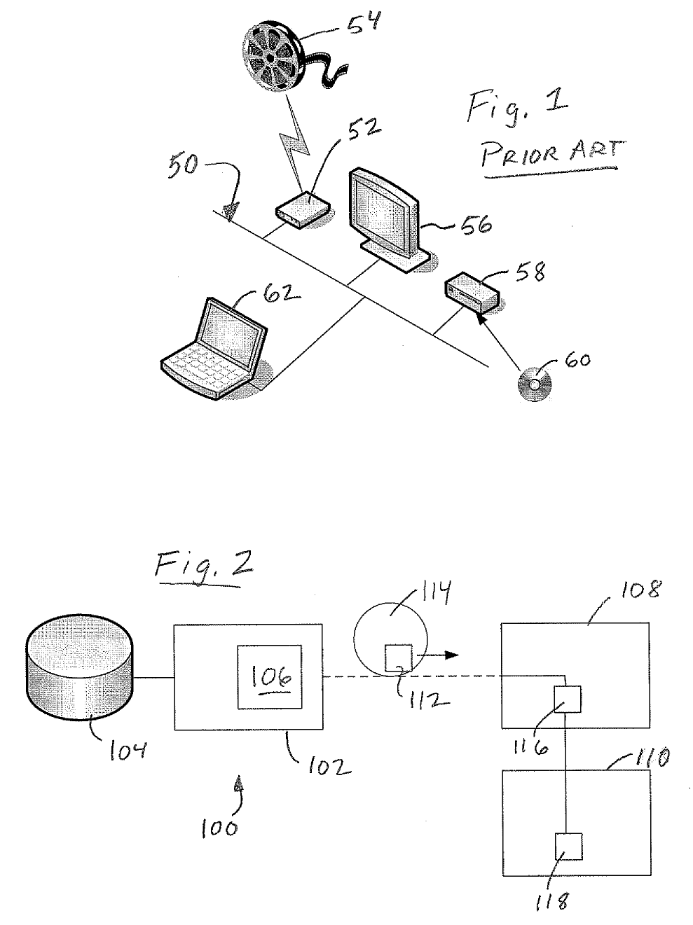

FIG. 2 shows exemplary elements of a system 100 for managing release of revocation messages in a content protection system. The system may comprise a computer 102 operatively associated with a database 104 of unauthorized devices to be prevented from receiving protected content. More exactly, database 104 may contain records of these unauthorized devices, including identifiers for the devices and other information associated with each identifier, as disclosed in the foregoing summary and elsewhere in the specification. Any suitable database may be used, including alternative forms of storing information in an organized fashion. The invention is not limited by the form of information storage employed. Likewise, any suitable computer 102 may be used. Various suitable computers and databases are known in the art. Database 102 should not be limited by storage constraints applicable to SRM lists maintained in compliant content-receiving devices, and should be capable of storing any useful amount of information.

Computer 102 may be configured for selecting records from the database to include in each of successive lists of revoked devices, such as in an SRM list. The computer may be configured such that at least some of the records appear only in cyclically appearing ones of the successive lists, separated by other ones of the successive lists. For example, some records may be selected to appear in every other list, others in every third list, and still others in every list. Various ways to accomplish this result should be apparent to one of ordinary skill. In an embodiment of the invention, computer 102 may run an application 106 programmed to select records from the database 104 according to criteria such as discussed in the summary above and elsewhere in the specification.

Application 106 may be programmed with various selection rules ensuring that, in appropriate circumstances, selected records appear only in cyclically appearing ones of a sequence of SRM lists, separated by other SRM lists that do not contain these records. For example, given a defined SRM list size, and a number of revocation messages to be distributed such as may be determined by searching database 104 at any particular time, application 106 may define a SRM list cycle. A list cycle may comprise any plural number of successive lists, such as two or more. When a cycle is completed, a new cycle begins.

Computer 102 may also be configured, such as via application 106, to generate drafts of each list appearing in a cycle, populated with revocation messages based on selections made in database 104. The draft lists may then be released in succession, separated by the desired intervals. In the alternative, and for further example, the application may populate each list as it is needed, while keeping track of the content of past SRM lists to ensure that the desired cyclical distribution of revocation messages occurs. Whatever approach is used, the computer may be configured for generating successive lists of revoked devices to be released to receiving devices, e.g., devices 108, 110, at periodic intervals.

Each released list 112 may be configured for preventing use of protected content by any device connected to a receiving device that is identified in a most recently-released one of successive lists of revoked devices, in any suitable fashion known in the art. Each released list 112 may also be associated with protected or unprotected content 114 as specified by the applicable content protection standard. Any suitable mode of transmission may be used for content 114 and SRM list 112, including, for example, terrestrial broadcast, satellite broadcast, cable transmission, network download using Internet Protocol or other protocol, wireless transmission over a telephone network, distribution on physical media such as on optical disk or magnetic tape or in electronic memory devices, or any combination of the foregoing. Embodiments of the revocation message cycling method are not limited to a particular transmission or distribution mode. As explained in connection with FIG. 1 above, the most current version of each released list may be retained in a memory 116 of the receiving device 108 receiving content 114 and associated SRM list 112. From there, the list 112 may be promulgated to other devices connected to first receiving device 108. For example, if device 108 comprises a set-top cable box, digital tuner or satellite receiver, device 110 may comprise a digital TV that stores list 112 in memory 118 when content 114 is played. From there, the list may be promulgated to other receiving devices connecting to the display device 110. Each list 112 comprises tangible information retained for use by receiving devices.

Computer 102 may be further configured for selecting records for use in an SRM list cycle in a priority order, based on an associated threat index. The threat index may be associated with an identifier for each rogue device retained in database 104, or may be calculated from other information associated with the rogue device, including but not limited to information concerning the population of particular rogue devices in particular geographic area, particular distribution channels, or both. In general, use of a threat index with SRM cycling may be designed so as to cause maximal disruption to unauthorized use of rogue devices, while having minimal or no noticeable effect on use of legal reception devices. Further details concerning threat indices are disclosed in the summary above, and elsewhere in the specification.

Computer 102 may be further configured for selecting records for including in an SRM list cycle based on an associated geographic identifier. For example, different list cycles may be generated for different regions. Further details concerning use of geographic regions are disclosed in the summary above, and elsewhere in the specification.

In an embodiment of the invention, the computer may be further configured for selecting the records appearing in a list such that higher-priority records, for example records for those rogue devices believed to pose a higher risk for unauthorized use of protected content, appear more frequently in the successive lists than lower-priority records. For example, the computer may be further configured for selecting the records such that highest priority records appear in consecutive ones of successive SRM lists. In general, the computer 102 should be configured for generating the successive SRM lists such that fewer records are in each of the successive lists than are in the database.

After an SRM list is generated, it may be released as the most-recent revocation list according to the applicable content protection standard. Operation of the CPS may be such that the most recent revocation list supersedes any earlier version present in the receiving device. In addition, or in the alternative, the SRM list may be accompanied by a message that forces it to be adopted by the receiving device, regardless of the version number. A forced “use-me” message of this type may be useful for avoiding depletion of available version numbers, if needed. A “use-me” message may be applied, for example, to reset the latest SRM version number to zero (or some other low version number) as needed. For further example, by applying the “use-me” message with every release of the SRM list, it may be used to render version numbers entirely superfluous. The computer may thus be further configured for releasing the successive lists to receiving devices at periodic intervals according to any of the foregoing methods.

It should be appreciated that releasing a particular SRM list for broadcast or other distribution may generally involve various intermediate steps in accordance with technical and administrative requirements of the chosen distribution mode and content protection system. These intermediate steps will vary depending on the circumstance and should be apparent to one of ordinary skill. After release, each SRM list should, after downstream processing and transmission, be received by compliant reception devices.

Release of completed SRM lists in a succession of lists may occur at various intervals. For example, the computer may be configured for releasing the successive lists at periodic intervals of less than ten seconds, ten minutes, ten hours, ten days, or not less than ten days. Any desired interval may be used that is compatible with the chosen transmission mode and content protection system.

FIG. 3 shows an exemplary data structure 300 such as may be used to construct each list 350 in a succession of cyclical revocation lists. Data structure 300 may be stored in any suitable database or memory structure. Each column in structure 300 indicates a type of data field and each row indicates a record, with two exemplary rows shown and six exemplary data fields. A first field 301 may be used to contain identifiers 302 for rogue devices that have been detected. Such identifiers may comprise identification data for each rogue device of interest, the data being compliant with the applicable DTCP standard. A second field 303 may be used to contain an indication of when each identifier 302 was added to the data structure. A third field 305 may be used to indicate when 306, if known, that the rogue device was first released in the affected region.

A fourth field 307 may indicate threat index scores 308 associated with each rogue device. Calculation of a threat index may be according to any desired method, and use of a threat index is optional. In addition to other information recorded in data structure 300, a threat index may be provided as an independent measure of risk associated with a rogue device, which may be useful in prioritizing the frequency with which a particular rogue device is identified in the SRM list cycle or otherwise selecting records from data structure 300. A threat index may incorporate factors such as total estimated population of a device, population per distribution channel, population per geographic area, device quality, source, price, or any other information that is believed relevant to assessing relative risks posed by different channels. In the alternative, or in addition, any or all of these factors may be used independently to select and prioritize records for inclusion in SRM lists. The disclosure of a separate threat index is merely exemplary, and it should be understood that SRM lists may be prioritized using factors such as described herein without distilling such factors in an index value, however convenient it may be to do so.

A sixth field 309 may contain region indicators 310 associated with each record, for use in generating region-specific SRM list cycles, or other use. A seventh field 311 may contain numeric estimates 312, if available, of the number of distributed duplicates of an associated rogue device. Such information may be useful, for example, in prioritizing the frequency with which a particular rogue device is identified in the SRM list cycle or otherwise selecting records from data structure 300. Any useful number and type of fields may be used in data structure 300, and the depicted fields are merely exemplary. Data structure 300 should at minimum, however, contain appropriate identifiers for rogue devices to be included on SRM lists.

Data concerning rogue devices may be collected in any suitable manner and provided to an SRM administrator, who may administer the data structure 300. The SRM administrator may process the data concerning rogue devices to compile a database or list of rogue devices that associates an identifier for each rogue device with one or any of a time-related threat index, a distribution channel related threat index, and a region-related threat index. For example, if the SRM administrator believes that a particular rogue device that was first discovered on Jan. 1, 2007 has been very widely distributed, the administrator may assign a high threat level index associated with the 1/1/07 date. For further example, if the rogue device is known to be generally available in Asia but not in North America, the administrator may assign a high threat index for Asia and a low threat index for North America. Still further, some devices may be assigned a high threat index in one distribution channel, while having a low or zero threat index in other channels. For example, a rouge DVD player may receive a high threat index for a DVD distribution channel while posing no or lower threats in other channels, such as cable, satellite, broadcast, or broadband distribution. Data structure 300 may be fluid and subject to revision at appropriate times to reflect new information or beliefs concerning extant rogue devices known to the administrator.

Data from data structure 300 may be selected and used to generate an SRM list 350, which may comprise a smaller data structure or package containing identifiers 354 for a plurality of rogue devices. List 354 may further comprise a header 352 containing a version identifier and other information as used by the selected content protection scheme to distribute and apply revocation messages for rogue devices.

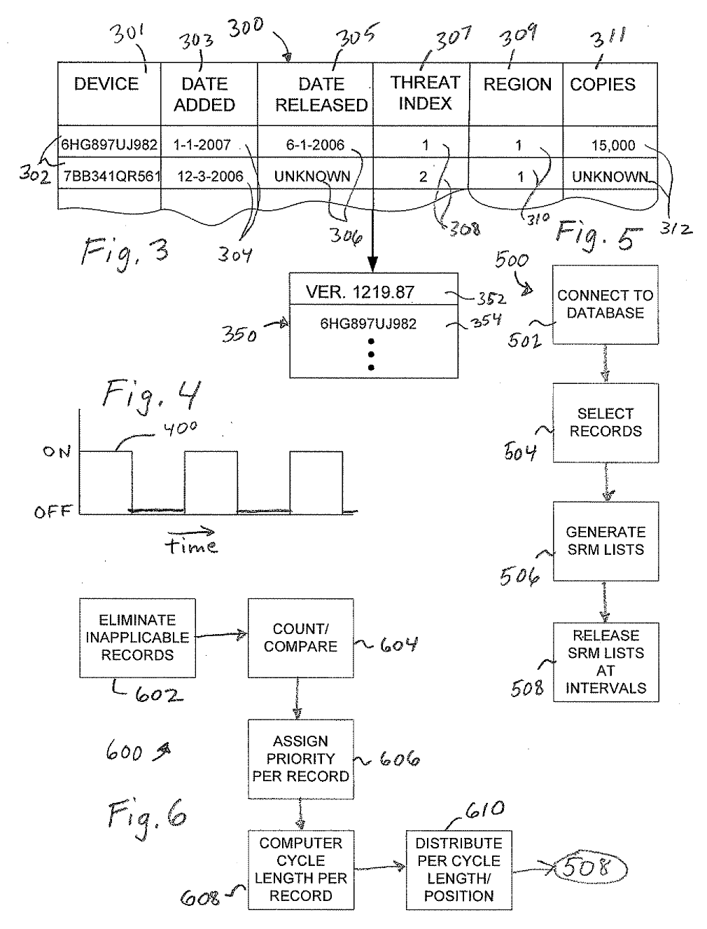

FIG. 4 shows an exemplary effect of implementing a cyclical SRM succession according to the embodiments disclosed herein on particular rogue devices that are identified on at least one, but not all, revocation lists of a cycle. The chart line 400 indicates that the rogue device oscillates between two states. For some portion of the cycle, the device is in a revoked state, indicated by “OFF” in FIG. 4, during which the rogue device cannot make use of protected content. For the remainder of the cycle, the device is in an unrevoked state, indicated by “ON,” during which the device may be able to make use of protected content. The chart indicates that the frequency at which the rogue device oscillates between “ON” and OFF” may be selected so as to optimally prevent or discourage unauthorized use of protected content. Although the depicted cycle shows a 50% distribution between “ON” and “OFF” states, other distributions may be useful, including, for example, cycles in which the “OFF” portion of the cycle comprises 33.3%, 25%, 20%, 16.7%, or 15% of the total cycle time. In the alternative, or in addition, irregular cycles may also be effective in discouraging use of rogue devices for accessing protected content.

FIG. 5 shows exemplary steps of a method 500 for managing release of revocation messages in a content protection system. At step 502, a connection to a database or other storage structure for rogue device data is made. For example, data concerning rogue devices may be accessed by generating an SQL query to a local or remote database. In the alternative, such data may be stored locally in a data list or table of any type. Preferably, the data may be accessed in a form for automatic analysis and selection of rogue device identifiers using a selection algorithm.

At step 504, records may be selected from the data table or list to include in one or more instances of a revocation message list included in a succession of lists comprising a revocation cycle. An algorithm may apply a set of prioritization rules to data in an administrative database to select records for an SRM list that is compliant with the applicable DTCP or other standard. For example, to produce a list for distribution in Region 1, the algorithm may exclude records for every rogue device that is not listed as a threat in Region 1. In addition, or in the alternative, the algorithm may apply a time-based criterion to rank rogue devices in a priority order according to threat index and age. For example, a more recently-discovered rogue device may be ranked higher in the SRM-list than an older device having the same threat index. Selection criteria may be adapted as more is learned about the operation and distribution of rogue devices. For example, population distribution of rogue devices in particular geographic areas and distribution channels may be important in developing a threat index or selecting records for an SRM list. Selection should include consideration of past lists that particular identifiers were included in. Further details concerning an exemplary selection process are provided below, in connection with FIG. 6.

At step 506, successive lists of revocation messages may be generated using a generating module or application. Draft lists may be generated in advance and released in the desired sequence at the desired intervals. In the alternative, each revocation message list may be generated as needed. In the latter case, data concerning past releases of a revocation list may be used to construct current lists according to the desired cyclical pattern. For example, if an identifier for a particular rogue device is to be included only in every other release of the revocation list, it may be excluded from the current list if it is contained in the last released list. In either case, previously released lists may be retained for archival purposes.

After being generated, revocation message lists, e.g., SRM lists, may be released at intervals to receiving devices, as indicated as step 508. The manner of release should be determined by the relevant media for protected content associated with the SRM list. For example, if the list is to be associated with content broadcast using a digital television signal, release may occur by associating an SRM list with content scheduled to be broadcast at a particular time, or otherwise incorporating the list into digital data scheduled for broadcast, digital cable transmission, or digital satellite transmission. For further example, an SRM list may be included with content data to be encoded on a tangible media, such as on a DVD, HD-DVD, Blu-Ray, or other media. Successive versions of SRM lists may be released at any desired interval.

It should be appreciated that release of an SRM list cycle to one or more receiving devices comprises a tangible, concrete and useful result from application of method 500. Each list in a SRM information cycle is encoded in a tangible electronic form and stored in memories of receiving devices. Method 500 and other methods disclosed herein may also result in other tangible, concrete and useful results. For example, transmission of a list cycle to compliant devices may cause the devices to alter their output to any connected rogue device, by refusing to provide authentication keys. Consequently, output of rogue devices may be disrupted according to a pattern as described in connection with FIG. 4, as their access to protected content is similarly disrupted.

FIG. 6 shows exemplary steps of a method 600 for selecting records from an administrative database for inclusion in distributed SRM lists. At step 602, after accessing a database or other data structure containing records of rogue devices, pertinent records may be extracted from the available data so as to eliminate inapplicable records. Inapplicable records may include, for example, records for rogue devices that are not present in a targeted geographic region or distribution channel, that present a threat index lower than a specified minimum threshold, that are indicated as inactive, too old, or otherwise inapplicable.

At step 604, extracted records may be counted and compared with a desired revocation message list size. For example, DTCP may specify a minimum storage for compliant devices capable of storing ‘X’ number of records identifying rogue devices. A number of extracted records may be ‘Y,’ where ‘Y>X’ and ‘Y/X>1’. If ‘X’ is greater than or equal to ‘Y’, there is no need for revocation message cycling.

At step 606, a priority may be determined for each extracted record. For example, the records may be ranked from “highest threat” to “lowest threat” based on any useful index or criteria, some examples of which have been provided above. An assessment of priority level may be previously determined and stored in association with each record, computed just prior prioritizing the records, or some combination of the foregoing. In the alternative, the records may be prioritized according to any other desired criteria, or left in the order extracted from the database, or put in a random order.

In circumstances where the number of active rogue devices exceeds available SRM list space, it is of course not possible to disable 100% of non-compliant devices 100% of the time. However, by intelligent selection of records and using efficient cycling patterns, it should be possible to maximally disrupt unauthorized use of illegal reception devices without disrupting legal devices. Thus, economic incentives for distributing or owning illegal devices may be greatly reduced or eliminated, without increasing the cost of legal devices or impacting their operation.

At step 608, a cycle frequency may be determined for every extracted record. For example, if Y/X=2, the cycle frequency for every selected record may be set equal to two, meaning that every record may appear in every other distributed revocation message list. This simple set of circumstances would rarely exist in practice. Normally, for example, the ratio Y/X would not be equal to an integer. At the same time, it is desirable to utilize all memory that reception devices are required to allocate to storing SRM's, so it is generally less desirable to generate SRM lists that do not utilize all allocated memory. In other words, SRM lists should not be shorter than needed. Also, it may be desirable to cycle revocation messages for higher-threat rogue devices more frequently than for lower-threat rogue devices, and thereby more heavily disrupt use of higher-threat devices. Therefore, more complex determinations of cycle length may be desirable to more optimally accommodate these objectives and constraints.

For example, different cycle lengths may be assigned depending on an estimated threat index or other criteria. In an embodiment of the invention, revocation records may be grouped separately to be independently cycled within the same sequence of revocation message lists. For example, highest-priority records (“Group ‘A’”) may be assigned a cycle length of 1, meaning that they should appear in every released SRM list. A group of second priority records (“Group ‘B’”) may be assigned a cycle length of 2, meaning these appear in every other released list. A lower-priority group of records (“Group ‘C’”) may be assigned a cycle length of 3, meaning these appear in every third released list. In general, according to the foregoing example, Y=A+B+C, while A+B/m+C/n=X, where ‘m’ and ‘n’ are the cycle lengths of Groups B and C, respectively, and A, B, C represent the number of records in each group. In addition, in this example n=m+1. Also, because it is desirable to ensure that every record appears once during its corresponding cycle, n>Y/X. Given fixed values for Y and X, an algorithm may readily be developed to choose useful values for A, B, C, m, and n such that the foregoing expressions are true. It should be apparent that any number of groups may be used, and that various other useful methods of computing cycle lengths may be developed by those of ordinary skill.

After one or more cycle lengths are determined, each record may be distributed to an SRM list at step 610, depending on its assigned cycle length, position in the list, and priority. One or more records may be written to lists that are used to generate a succession of revocation message lists for release to receiving devices. A particular cycle may begin or terminate at any record of a revocation message list. For example, a cycle may begin at the first record of a first list and end at a last record of a second list. For further example, a cycle may begin and end after any ‘Y’ number of records, regardless of the first or last position on a list. While a cycle may begin or end at any position on a list, a cycle should comprise a plurality of separate revocation message lists configured for release at intervals in succession. Any number of SRM lists consistent with determined revocation cycles may be stored in a computer memory for release at intervals as described above in connection with FIG. 5

Having thus described a preferred embodiment of revocation message cycling in a DTCP system, it should be apparent to those skilled in the art that certain advantages of the within system have been achieved. It should also be appreciated that various modifications, adaptations, and alternative embodiments thereof may be made within the scope and spirit of the present invention. For example, a method and system for use with the DTCP standard has been illustrated, but it should be apparent that the inventive concepts described above would be equally applicable to other content protection systems that support revocation messaging. The invention is defined by the following claims.

What is claimed is:

1. A method for managing release of revocation messages in a content protection system, comprising:
connecting to a database of unauthorized devices to be prevented from receiving protected content;
selecting records from the database to include in each of successive lists of revoked devices, such that the records appear only in cyclically appearing ones of the successive lists separated by other ones of the successive lists; and
generating the successive lists of revoked devices to be released to receiving devices at periodic intervals, configured for preventing use of the protected content by any device connected to the receiving devices that is identified in a most recently-released one of successive lists of revoked devices.

2. The method of claim 1, further comprising transmitting the successive lists of revoked devices to the receiving devices.

3. The method of claim 2, further comprising transmitting the successive lists using a transmission mode selected from terrestrial DTV broadcast, digital cable transmission, Internet protocol, telephone line transmission, or wireless telephone transmission.

4. The method of claim 1, further comprising distributing the successive lists of revoked devices to the receiving devices encoded on a tangible media.

5. The method of claim 4, further comprising distributing the successive lists encoded on the media selected from an optical disk media, a magnetic disk media, a magnetic tape media, and an electronic memory device media.

6. The method of claim 1, further comprising selecting the records in a priority order based on an associated threat index.

7. The method of claim 6, wherein the threat index is based at least in part on information about population of non-compliant devices in a group selected from: receiving devices in defined distribution channels and receiving devices in defined geographic areas.

8. The method of claim 1, further comprising selecting the records based on an associated geographic identifier.

9. The method of claim 1, further comprising selecting the records such that higher-priority records appear more frequently in the successive lists than lower-priority records.

10. The method of claim 8 further comprising selecting the records such that highest priority records appear in consecutive ones of the successive lists.

11. The method of claim 1, wherein fewer records are in each of the successive lists than are in the database.

12. The method of claim 1, further comprising releasing the successive lists to the receiving devices at periodic intervals.

13. The method of claim 12, wherein the successive lists are released at periodic intervals of less than ten seconds.

14. The method of claim 12, wherein the successive lists are released at periodic intervals of less than ten minutes.

15. The method of claim 12, wherein the successive lists are released at periodic intervals of less than ten hours.

16. The method of claim 12, wherein the successive lists are released at periodic intervals of less than ten days.

17. The method of claim 12, wherein the successive lists are released at periodic intervals of not less than ten days.

18. A system for managing release of revocation messages in a content protection system, comprising:
a computer operatively associated with a database of unauthorized devices to be prevented from receiving protected content, the computer configured for:
selecting records from the database to include in each of successive lists of revoked devices, such that the records appear only in cyclically appearing ones of the successive lists separated by other ones of the successive lists; and
generating the successive lists of revoked devices to be released to receiving devices at periodic intervals, configured for preventing use of the protected content by any device connected to the receiving devices that is identified in a most recently-released one of successive lists of revoked devices.

19. The system of claim 18, wherein the computer is further configured for transmitting the successive lists of revoked devices to the receiving devices.

20. The system of claim 19, wherein the computer is further configured for transmitting the successive lists using a transmission mode selected from terrestrial DTV broadcast, digital cable transmission, Internet protocol, telephone line transmission, or wireless telephone transmission.

21. The system of claim 18, wherein the computer is further configured for distributing the successive lists of revoked devices to the receiving devices encoded on a tangible media.

22. The system of claim 21, wherein the computer is further configured for distributing the successive lists encoded on the media selected from an optical disk media, a magnetic disk media, a magnetic tape media, and an electronic memory device media.

23. The system of claim 18, wherein the computer is further configured for selecting the records in a priority order based on an associated threat index.

24. The system of claim 23, wherein the threat index is based at least in part on information about population of non-compliant devices in a group selected from: receiving devices in defined distribution channels and receiving devices in defined geographic areas.

25. The system of claim 18, wherein the computer is further configured for selecting the records based on an associated geographic identifier.

26. The system of claim 18, wherein the computer is further configured for selecting the records such that higher-priority records appear more frequently in the successive lists than lower-priority records.

27. The system of claim 26, wherein the computer is further configured for selecting the records such that highest priority records appear in consecutive ones of the successive lists.

28. The system of claim 18, wherein the computer is further configured for generating the successive lists such that fewer records are in each of the successive lists than are in the database.

29. The system of claim 18, wherein the computer is further configured for releasing the successive lists to the receiving devices at periodic intervals.

30. The system of claim 18, wherein the computer is further configured for releasing the successive lists at periodic intervals of less than ten seconds.

31. The system of claim 18, wherein the computer is further configured for releasing the successive lists at periodic intervals of less than ten minutes.

32. The system of claim 18, wherein the computer is further configured for releasing the successive lists at periodic intervals of less than ten hours.

33. The system of claim 18, wherein the computer is further configured for releasing the successive lists at periodic intervals of less than ten days.

34. The system of claim 18, wherein the computer is further configured for releasing the successive lists at periodic intervals of not less than ten days.
